(19) United States
(12) Patent Application Publication
(10) Pub. No.: US 2010/0027928 A1
(43) Pub. Date: Feb. 4, 2010

(54) RADIAL BEARING

(75) Inventor: Georg Draser, Nurnberg (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 12/509,566

(22) Filed: Jul. 27, 2009

(30) Foreign Application Priority Data
Jul. 30, 2008 (DE) 102008035691.3

(51) Int. Cl. F16C 19/04

(52) U.S. Cl. 384/456

(57) ABSTRACT

A radial bearing (1) made from at least three assemblies (10, 20, 30). The first assembly (10) is a first needle bearing (11), the second assembly (20) is a radial sealing element (21), and the third assembly (30) is a second needle bearing (31). The radial sealing element (21) sits on an inner sleeve (22) that has rims (23) on the end (22₁) facing the first needle bearing (11) and on the end (22₂) facing the second needle bearing (31). The rim (23) has radially distributed holding elements (24), wherein each of the holding elements (24) and each counter-holding element (13) interact such that the inner sleeve (22) and the corresponding needle bearing (11, 31) can be connected to each other by a clip mechanism.

### CROSS-REFERENCE TO RELATED APPLICATIONS

This application claims the benefit of German Patent application DE 10 2008 035 691.3, filed Jul. 30, 2008, which is incorporated herein by reference as if fully set forth.

### BACKGROUND

The present invention relates to a radial bearing made from at least three assemblies. The first assembly is composed of a first radial bearing. The second assembly is composed of a radial sealing element. The third assembly comprises a second needle bearing.

U.S. Pat. No. 5,619,130 shows an arrangement with which an annular element is mounted on a shaft. The annular element has a locking part on the inner surface, wherein this locking part engages with an annular locking groove. The annular groove is here formed on the outer periphery of the shaft. The document does indeed show a uniform component, but it is not comprised of several separate elements composed of merely bearing elements and merely sealing elements.

European Patent No. 0 597 438 B1 shows a radial needle bearing unit with integrated radial-axial sealing and axial support, with an outer sleeve with at least one rim pointing inward and a cage guiding the needles, wherein this cage is in connection with a stop disk and an elastic ring lying within the outer sleeve. The sealing and bearing elements are here indeed arranged in one component, but do not themselves form separate components. Furthermore, the bearing and sealing elements are arranged on different planes within the housing to be sealed.

U.S. Pat. No. 6,224,063 B1 discloses a sealing arrangement. The sealing arrangement here comprises two sealing rings that are spaced apart from each other in the axial direction and that are held in an annular holder. For this purpose, corresponding recesses are formed in the annular holder. The document discloses nothing, however, proposing an arrangement with which a simultaneous bearing and sealing could be achieved.

A radial-axial seal and an arrangement for bearing and radial-axial sealing are known. The radial-axial seal is arranged between a housing and a rotating shaft. The radial-axial seal comprises a cage with two rims and a sleeve that has two similarly formed rims. A sealing element is set between each rim of the cage and each rim of the sleeve. The sleeve is mounted by a press fit on the housing or on the shaft. In order to also provide the radial-axial seal with a bearing, two needle bearings of the radial-axial seal are installed in series at the sides of the radial-axial seal.

### SUMMARY

The objective of the present invention is to create a radial bearing that is easy to assemble and that reduces the costs in the assembly of the radial bearing.

This objective is met by a radial bearing that comprises the features of the invention.

The radial bearing according to the invention is here comprised of at least three assemblies. The first assembly is a first needle bearing, the second assembly is a radial sealing element, and the third assembly is a second needle bearing. The radial sealing element is mounted on an inner sleeve. The first needle bearing and the second needle bearing attach to the ends of the inner sleeve. At each of its ends, the inner sleeve has a rim. The rim comprises several radially distributed holding elements that interact with corresponding counter-holding elements of the needle bearing. The holding elements and the corresponding counter-holding elements are here constructed such that the inner sleeve and the corresponding needle bearing can be connected to each other by a clip mechanism.

The radial sealing element comprises several sealing rings that are each spaced apart from each other by a spacer part. These sealing rings and the spacer parts surround the inner sleeve.

The ends of the inner sleeve can be formed in various ways. One possibility is that the inner sleeve has a fixed rim formed on both its first end and on its second end. Another possibility is that the inner sleeve has a fixed rim formed on its first end and a flanged rim formed on its second end. Another possibility is that the inner sleeve has a flanged rim formed on both its first end and on its second end.

The fixed rim has the radially distributed holding elements formed on its inner diameter. The holding elements are formed as holding tabs. An axial disk is crimped rigidly on the flanged rim. The axial disk has the same outer diameter as the contours of the fixed rim. The axial disk similarly has radially distributed holding elements, wherein these holding elements are also formed as holding tabs and correspond to the holding tabs on the fixed rim.

The holding tabs of the inner sleeve interact with the corresponding counter-holding elements of the needle bearing. The counter-holding element has a step in which engages the corresponding holding tab on the fixed rim or on the axial disk.

The inner sleeve and the two or more needle bearings are produced without cutting. There is also the possibility that the two or more needle bearings have the same diameter. It is also conceivable that the two or more needle bearings have different diameters.

The inner sleeve has radial boreholes that permit a flow of lubricant. The inner sleeve produced without cutting is provided with the radial boreholes and the sealing rings with the spacer parts are mounted on the outer diameter between the rims. The radial boreholes allow for a selective control of lubricant flow (oil-flow control), wherein a needle bearing produced without cutting is formed on both sides on the inner sleeve of the sealing element. The entire assembly made from the sealing element and the two or more needle bearings is clipped together. This unit could be assembled relatively easily by the customer in one assembly process.

### BRIEF DESCRIPTION OF THE DRAWINGS

Below, embodiments shall explain the invention and its advantages in greater detail with reference to the enclosed figures.

FIG. 1 shows a schematic diagram of a radial-axial seal according to the state of the art,

FIG. 2 shows a schematic view of the connection between the inner sleeve and one of the needle bearings in use,

FIG. 3 shows another embodiment of the connection between the inner sleeve and the needle bearing,

FIG. 4 shows a section view of the assembled unit that is made from two needle bearings and a sealing element,

FIG. 5 shows a schematic side view of the pre-assembled assembly made from the two needle bearings and the sealing element,

FIG. 6 shows a perspective view of an axial disk that is connected to the flanged rim, and

FIG. 7 shows a perspective view of the inner sleeve on which the sealing elements are mounted on the outer diameter.

### DETAILED DESCRIPTION OF THE PREFERRED EMBODIMENT

Before the following description it should be noted that the same reference symbols are used in different figures for the same features. For elements of the invention that are identical or that have identical actions, identical reference symbols are used. Furthermore, for the sake of clarity, only reference symbols that are necessary for the description of the figure in question are shown in the individual figures. The shown embodiments represent merely examples of how the radial bearing according to the invention could be constructed and thus do not represent a conclusive limitation of the invention.

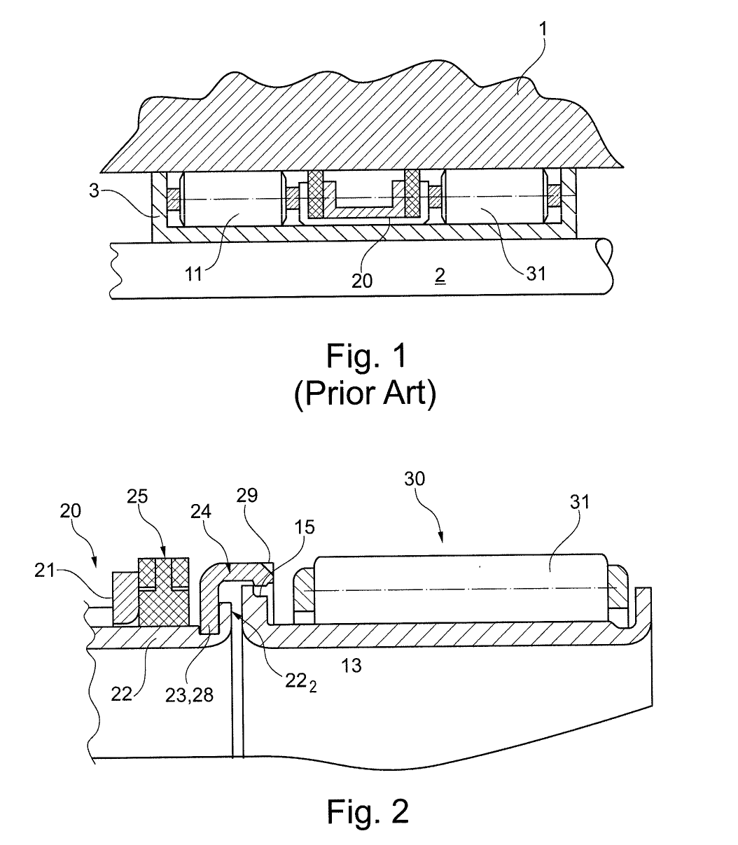

FIG. 1 shows a schematic arrangement for bearing and radial-axial sealing between a housing 1 and a moving element 2. In the embodiment shown here, the moving element 2 is a shaft. The arrangement for the bearing and radial-axial seal is arranged in the embodiment shown here on a common carrier 3. A first bearing 11 and a second bearing 31 that are both supported on the rims of the carrier 3 are provided. A radial-axial seal 20 is arranged between the first bearing 11 and the second bearing 31. The first bearing 11 and the second bearing 31 are here also supported on the corresponding rims of the radial-axial seal 20. The carrier 3 is here mounted on the moving element 2 by a press fit.

FIG. 2 shows an enlarged view of the interaction of the third assembly 30 with the second assembly 20. The second assembly includes the sealing element 21 and the third assembly 30 is the second needle bearing 31. In the embodiment shown, the radial sealing element 21 sits on an inner sleeve 22. In this embodiment, the inner sleeve 22 has, on the end 22₂ facing the second needle bearing 31, a rim 28 that is constructed as a flanged rim. An axial disk 29 is crimped rigidly on the flanged rim 28. The axial disk 29 has several holding elements 24. The holding elements 24 interact with a corresponding counter-holding element 13 of the second needle bearing 31. For mounting, each needle bearing 11, 31 is clipped together with the corresponding sealing element 21 or the inner sleeve 22 of the sealing element 21. The holding tabs 24 of the inner sleeve 22 are formed uniformly on both sides and interact with the corresponding counter-holding element 13. The counter-holding element 13 has a step 15 in which the corresponding holding tab of the holding element 24 of the inner sleeve 22 engages.

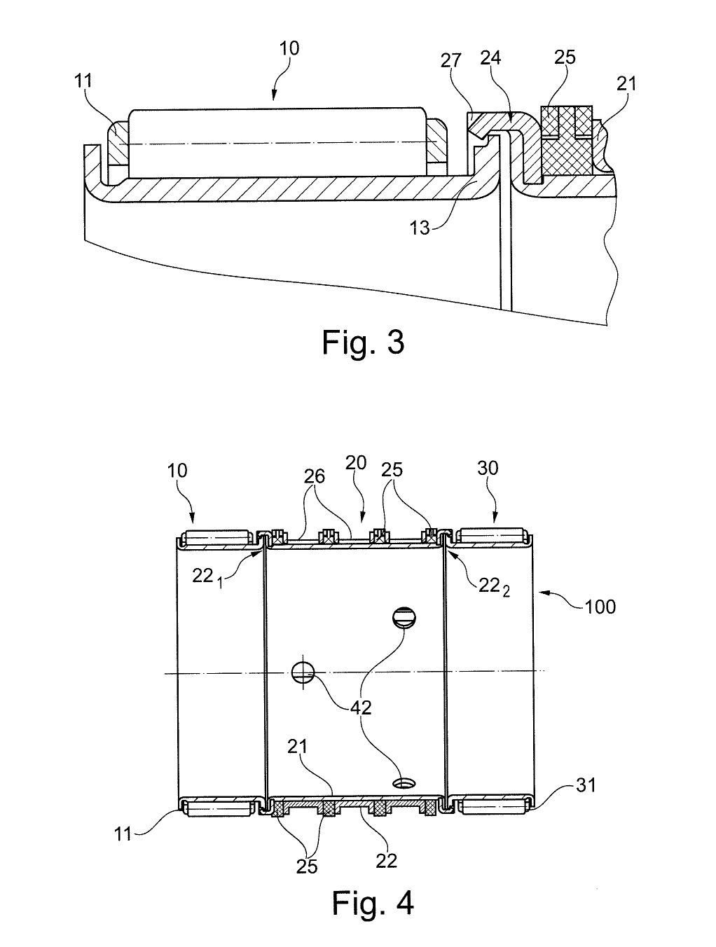

FIG. 3 similarly shows an enlarged view of the interaction of the first needle bearing 11 with the sealing element or the inner sleeve 22 of the sealing element 21. In the embodiment shown here, the end 22₁ of the inner sleeve 22 facing the first needle bearing 11 is provided with a rim 23. The rim 23 is formed as a fixed rim 27. As already mentioned in the description to FIG. 2, the fixed rim 27 of the inner sleeve 22 similarly has holding elements 24. These holding elements similarly interact with a corresponding counter-holding element of the first needle bearing 11. The shape of the holding element of the fixed rim 27 is identical to the shape of the holding element 24 of the axial disk 29. Thus, the mechanism of the interaction of the first needle bearing 11 is also identical to the inner sleeve 22 of the sealing element 21.

FIG. 4 shows a schematic section view of the radial bearing 100. The radial bearing 100 comprises a first assembly 10, a second assembly 20, and a third assembly 30 that are both connected to each other by a clip mechanism. The first assembly 10 is a needle bearing 11. Similarly, the third assembly 30 is constructed as a needle bearing 31. Between the first needle bearing 11 and the second needle bearing 31 there is the second assembly that is constructed with a sealing element 21. The corresponding holding elements 24 (see FIG. 2 and FIG. 3) that interact with corresponding counter-holding elements 13 of the first needle bearing 11 and the second needle bearing 31 are formed on the first end 22₁ and on the second end 22₂ of the sealing element 21. The sealing element 21 is formed on an inner sleeve 22. The sealing element 21 comprises several sealing rings 25 that are spaced apart from each other by spacer parts 26. The number of spacer parts 26 or sealing rings 25 shown in FIG. 4 is merely one example for a plurality of possible configurations, and consequently should not be viewed as a limitation of the invention. The inner ring 22 has several radial boreholes 42 through which a lubricant flow is possible.

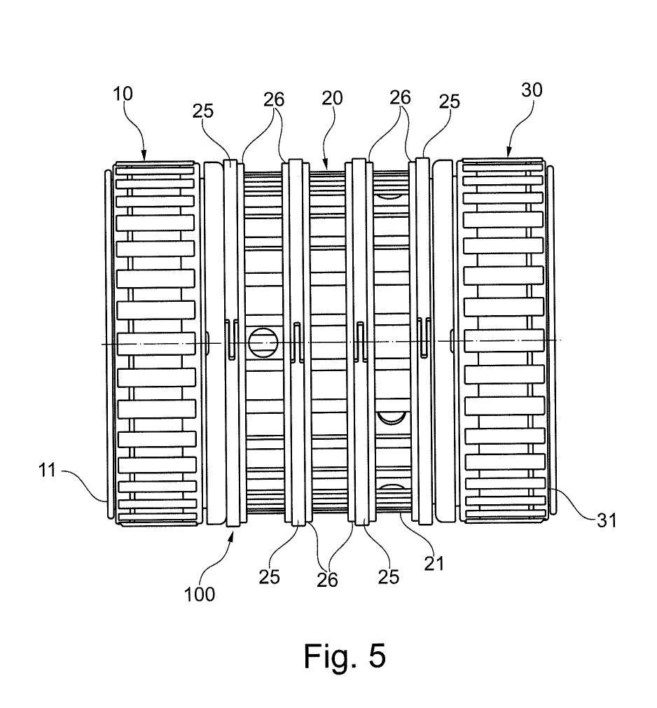

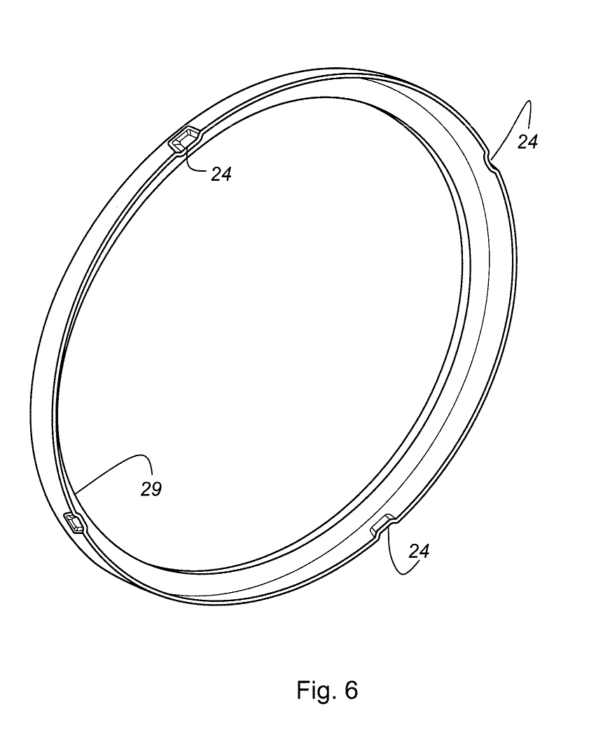

FIG. 5 shows a schematic side view of the assembled unit made from the first assembly 10, the second assembly 20, and the third assembly 30. As already mentioned several times, the first assembly 10 and the third assembly 30 are each comprised of a needle bearing 11, 31. Between the two needle bearings 11, 31, the sealing element 21 is provided as a second assembly. Although only three assemblies 10, 20, 30 are connected to each other by a clip mechanism in the embodiment shown here, it is imaginable at any time that more than three assemblies are connected to each other in the corresponding way, in order to thus construct bearing systems in simple and quick ways.

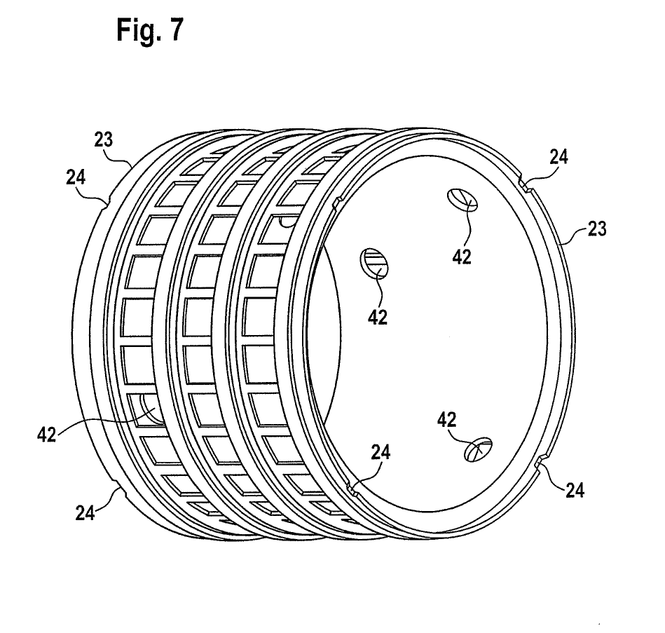

FIG. 6 shows a perspective view of the axial disk 29 that is crimped rigidly with the flanged rim 28. The holding tabs are formed as holding elements 24 on the outer diameter of the axial disk 29. The holding elements 24 are here arranged distributed uniformly in the radial direction on the outer periphery of the axial disk. Through this uniform distribution of the holding elements 24, a stable clip connection is achieved between the corresponding assemblies 10, 20, 30. The outer diameter of the axial disk 29 has the same contours as the fixed rim 27.

FIG. 7 shows a perspective view of the inner sleeve 22 that has a rim 23 on both ends. The rim 23 can here be formed by a fixed rim or by the outer contours of an axial disk. The inner sleeve 22 is provided with radial boreholes 42 that provide for the passage of lubricant (oil). As already mentioned several times, several holding tabs 24 are formed on the rims 23 of the inner sleeve 22, wherein these holding tabs provide the corresponding clip connection to the first needle bearing 11 and to the second needle bearing 31. The corresponding sealing elements 25 and the spacer parts 26 are arranged on the outer periphery of the inner sleeve 22. The inner sleeve 22 is produced without cutting. As shown in FIGS. 2 and 3, a needle bearing 11, 31 similarly produced without cutting is clipped on both sides to the inner sleeve 22 of the sealing element 21. In this way, a unit is produced that the customer could assemble in one assembly process. Thus, the assembly costs for this radial bearing are decreased.

With this clip mechanism, several needle bearings produced without cutting can be clipped together to form one assembled unit. Two or more needle bearings could be clipped to each other with an inner ring that has either fixed rims and/or flanged rims. It is also possible that the needle bearings have different diameters. Due to the principle of the present invention, many possible configurations of the radial bearing are possible.

The present invention has been described with reference to preferred embodiments. For someone skilled in the art it is obvious that changes and modifications can be made, without leaving the scope of protection of the following claims.

1. A radial bearing comprising at least first, second and third assemblies, the first assembly is a first needle bearing, the second assembly includes a radial sealing element, and the third assembly is a second needle bearing, the radial sealing element is located on an inner sleeve having a first end facing the first needle bearing and a second end facing the second needle bearing, each of the ends has a rim that includes radially distributed holding elements, and the needle bearings have counter-holding element on a side facing the inner sleeve, each of the holding elements and the corresponding counter-holding elements interact such that the inner sleeve and the respective needle bearings can be connected to each other by a clip mechanism.

2. The radial bearing according to claim 1, wherein the radial sealing element comprises several sealing rings that are spaced apart from each other by at least one spacer part.

3. The radial bearing according to claim 1, wherein the inner sleeve has a fixed rim on the first end and a fixed rim on the second end.

4. The radial bearing according to claim 1, wherein the inner sleeve has a fixed rim on one of the ends and a flanged rim on the other of the ends.

5. The radial bearing according to claim 1, wherein the inner sleeve has a flanged rim on the first end and a flanged rim on the second end.

6. The radial bearing according to claim 3, wherein the fixed rim has the radially distributed holding elements on an inner diameter thereof and the holding elements are formed as holding tabs.

7. The radial bearing according to claim 4, wherein an axial disk that has, on an outer diameter, the same contours as the fixed rim is crimped rigidly on the flanged rim, and the axial disk includes the radially distributed holding elements that are formed as holding tabs.

8. The radial bearing according to claim 7, wherein the holding tabs on the fixed rim and on the axial disk are the same.

9. The radial bearing according to claim 6, wherein the holding tabs of the inner sleeve interact with the corresponding counter-holding element of the needle bearing, wherein the counter-holding element has a step in which a corresponding one of the holding tabs engages.

10. The radial bearing according to claims 1, wherein the two or more needle bearings have the same diameter.

11. The radial bearing according to claim 1, wherein the two or more needle bearings have different diameters.

12. The radial bearing according to claim 1, wherein the inner sleeve has radial boreholes that allow a flow of lubricant.

13. The radial bearing according to claim 1, wherein the inner sleeve and the two or more needle bearings are produced without cutting.
